(19) United States
(12) Patent Application Publication
(10) Pub. No.: US 2010/0114966 A1
(43) Pub. Date: May 6, 2010

(54) Security audit in user interface mode

(75) Inventors: Nigel Smith, Redwood City, CA (US); Susan Stratton, San Mateo, CA (US); Nigel King, San Mateo, CA (US)

Correspondence Address: Kraguljac & Kalnay, LLC - Oracle, 4700 Rockside Road, Summit One, Suite 510, Independence, OH, 44131, US

(73) Assignee: Oracle International Corp, Redwood Shores, CA (US)

(21) Appl. No.: 12/288,529

(22) Filed: Oct. 21, 2008

(51) Int. Cl. G06F 17/30; G06F 7/00

(52) U.S. Cl. 707/785; 707/E17.005

(57) ABSTRACT

Systems, methods, and other embodiments associated with a security audit performed on a displayed page generated from an executing application are described. One example method includes determining one or more current objects on the displayed page and determining access rights to the one or more current objects. The method may further include comparing access rights of the one or more current objects to access rights assigned to a user to determine accessible objects and non-accessible objects. The accessible objects and the non-accessible objects are visually distinguished on the displayed page.

### BACKGROUND

Computing applications typically include secured objects that limit access to specific users with access authority. Secured objects may include data fields, tabs, and buttons that are on a displayed page. A run-time computing application may display multiple secured objects to a user on the displayed page. It is not always apparent by viewing the secured objects on the displayed page whether a user has authority to access a particular object. For example, a button on the displayed page may attempt to access employee salary information that the user does not have authority to access. The lack of access may be due to a mismatch between access rights of the user and the authority needed to view the employee salary information that the button attempts to access. However, the lack of access may also be due to an error in the run-time application. If the user expects to see salary information but instead sees an error or no information, the application will appear to the user to be behaving improperly and cause the user to take some action and/or begin troubleshooting to resolve the problem.

Troubleshooting problems may require the user must leave the run-time environment of the executing application and enter a development environment to perform debugging. Typically, the user will not have access to the development environment and would then contact a network administrator for assistance. A more efficient way of troubleshooting may be desired.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of a method associated with performing a security audit in user interface mode.

FIG. 2 illustrates one embodiment of a system associated with a security audit in user interface mode.

FIG. 3A illustrates an embodiment of a displayed page during run-time.

FIG. 3B illustrates an embodiment of the displayed page of FIG. 3B with visually distinguished objects.

FIG. 4 illustrates another embodiment of a method associated with performing a security audit in user interface mode.

FIG. 5 illustrates an example computing environment in which example systems and methods, and equivalents, may operate.

### DETAILED DESCRIPTION

Described herein are example systems, methods, example environments, and other embodiments associated with a security audit in user interface mode. In one embodiment, a security audit is provided for a displayed page that is executed from a run-time application. The displayed page may include objects like fields, tabs, buttons, menu entries, and so on. The security audit may determine the objects included on the displayed page and determine access rights to the objects on the displayed page. The security audit may also compare the access rights of the objects to access rights of a user accessing the displayed page. The comparison can determine accessible objects and non-accessible objects. In one embodiment, non-accessible objects are objects that the user has no authority or permission to access and accessible objects are objects that the user has authority or permission to access. Mismatched access rights can be made apparent to the user by visually distinguishing the accessible and non-accessible objects on the display. In this manner, the user can review the secured aspects of a page while reviewing the page itself during run-time.

In another embodiment, the security audit allows an audit of the security access rights on a displayed page in a run time application, without changing to a development mode to audit security access rights. Additionally, the security audit allows a user to visually determine the accessibility of secured objects on a displayed page in an executing application without having to find the secured objects and the security profile of the user while in a separate development mode. The visually distinguished objects can be easily checked by a user to locate mismatched access rights. In some applications, a high percentage of alleged application errors are caused by a user's insufficient access rights and not caused by a programming error in the application. Thus, a system administrator can quickly rule out or conclude that errors are caused by mismatched access rights before starting a time intensive debug operation.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, a programmable logic device, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. For purposes of simplicity of explanation, the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be used to implement an embodiment. Blocks may be combined or separated into multiple components. Furthermore, additional and/or alternative methodologies can employ additional, not illustrated blocks.

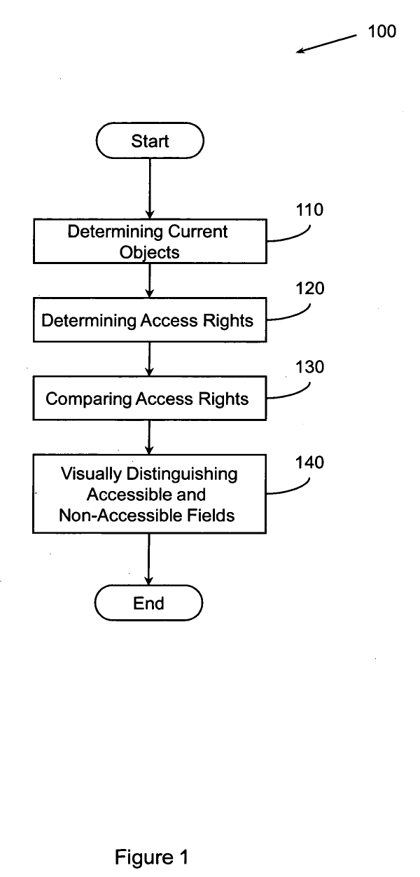

FIG. 1 illustrates one embodiment of a method 100 associated with performing a security audit. The security audit can be provided for a displayed page where the page is generated from an executing application (e.g. a displayed web page). The security audit may allow a user to identify mismatches or otherwise insufficient security access rights that prevent the user from accessing certain aspects of a page. The displayed page may be displayed on a display and the displayed page may include one or more objects. Current objects include objects currently displayed as part of the page and/or objects accessible from the page. For example, current objects may include fields, tabs, buttons, menu entries, functions callable within the displayed page, and so on.

As previously stated, a user may be viewing a displayed page from an application and one or more objects from the page may not be displaying properly and/or information may be block. The user may be expecting access to those objects and thus may believe the application is not operating properly. The security audit method 100 can then be initiated to provide a run-time determination of security rights.

With reference to FIG. 1, at block 110, the method 100 begins by determining the one or more current objects on the displayed page. The displayed page may be generated from an application in a run-time environment as previously explained. The method 100 continues, at 120, by determining access rights to the one or more current objects. An access right may be the authority/permission of a user to access a particular object from the page. The access rights may be defined, for example, by roles and privileges. A privilege may be assigned to a user to grant access to an object. Roles may group together privileges or other roles and grant multiple privileges or roles to a user. In one embodiment, roles and privileges are predetermined and assigned to a user or groups of users by a system administrator that are applied for selected applications and/or selected types of objects within an application.

With continued reference to FIG. 1 and block 120, in one embodiment, access rights may be determined for the one or more current objects, for example, by determining privileges of the one or more current objects that allow access to the current object. Access rights may also be determined for the one or more current objects, for example, by determining roles that allow access to the current objects.

The method 100 may further include, at 130, comparing access rights of the one or more current objects to access rights assigned to a user. The user may be currently accessing the displayed page while the comparison of access rights occurs. The comparison may determine accessible objects and non-accessible objects. Non-accessible objects include objects that the user has no authority to access (e.g. user does not have authority or appropriate access rights) and accessible objects include objects that the user has authority to access. The access rights may be compared by comparing roles and privileges assigned to a user with roles and privileges that have access to the one or more current objects. By comparing user access rights (e.g. user access security settings) to the access rights required by the current objects, a determination may be made as to whether the objects are accessible or non-accessible to the user.

Method 100 may also include, at 140, visually distinguishing the accessible and non-accessible objects on the displayed page. In one embodiment, the accessible and non-accessible objects can be visually distinguished by overlaying a visual graphic on the displayed page to visually distinguish the accessible objects from the non-accessible objects. For example, a visual graphic may be overlaid on the non-accessible objects on the displayed page to distinguish them from the accessible objects, or vice versa. In another embodiment, visually distinguishing can include displaying the accessible objects in a different color from the non-accessible objects, or vice versa. In another embodiment, a flashing indicator could be placed over the non-accessible objects to distinguish them from the accessible objects, or vice versa. Thus the visually distinguished objects on the displayed page serve to indicate access rights of the user to the objects while the user is still viewing the page itself during run-time.

In another embodiment, the method 100 may further include providing an option to activate the security audit on the displayed page. The security audit may be activated on the displayed page of the executing application, for example, by the user selecting a menu option or a button on the displayed page.

In another embodiment, the method 100 may include transmitting the displayed page, including the visually distinguished accessible objects and non-accessible objects to a privileged user (e.g. system or network administrator). For example the information from the displayed page can be sent to a remote system administrator that can use the information to assist the user in determining what errors occurred. The displayed page transmission may include transmitting the one or more current objects, the access rights that authorize access to the one or more current objects, and the access rights assigned to the user. In another embodiment, the privileged user may proxy as the user of the displayed page to allow the privileged user to interact with the displayed page as the user. For example, the privileged user may be able to access pages that are accessible from the displayed page by activating a button in the displayed page that connects to the accessible pages. In another example, the privileged user may access functions that the displayed page may run by activating a button in the displayed page.

In one embodiment, the displayed page is transmitted without including data displayed by the one or more current objects. For example, some sensitive information (e.g. employee salary information) may be too sensitive for privileged users like a network administrator to view. Thus, the raw data will not be transmitted and will not be viewable by the privileged user. However in one embodiment, the displayed page is transmitted in its original format with field names replacing the raw data in the data fields so the privileged user may still be able to view the displayed page.

In another embodiment, the method 100 may further include providing an option on the displayed page that when selected allows the access rights assigned to the user to be changed in run-time. This option to change the access rights may be provided and executed without having to enter a development mode. In yet another embodiment, the method 100 may include providing an option on the displayed page that when selected displays the access rights assigned to the user that is currently operating the executing application.

In still another embodiment, the method 100 may also include providing, on the displayed page, an option to select one of the one or more current objects. When an object is selected, a list of user roles and privileges that include access rights to the selected object can be displayed. This may allow a user or privileged user the ability to quickly determine the roles and privileges that grant access to the selected object. This may allow the user access rights to be quickly updated to allow access to the selected object.

While FIG. 1 illustrates various actions occurring in serial, it is to be appreciated that various actions illustrated in FIG. 1 could occur substantially in parallel. By way of illustration, a first process could determine current objects (block 110), a second process could determine access rights (block 120), and a third process could compare access rights (block 130). While three processes are described, it is to be appreciated that a greater and/or lesser number of processes could be employed and that lightweight processes, regular processes, threads, and other approaches could be employed.

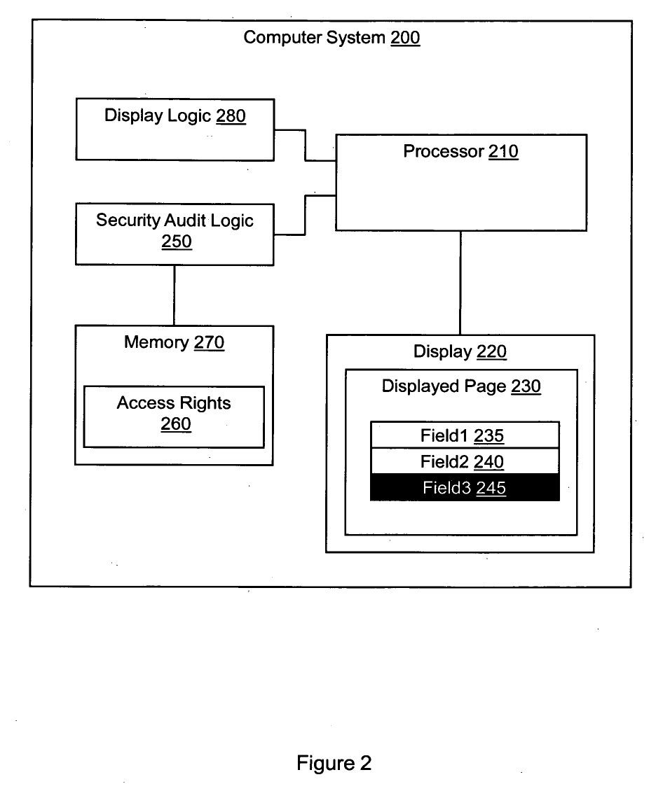

FIG. 2 illustrates one embodiment of a computer system 200 configured to perform a security audit in user interface mode. The security audit in user interface mode may allow the identification of mismatches of security access rights between users and objects displayed on a page as explained previously. Mismatched or otherwise insufficient access rights can prevent a user from viewing secured objects, which are viewable to users with the appropriate access rights.

The computer system 200 includes a processor 210 for executing an application or in a web based client-server environment where the computer 200 is the client, for executing instructions and/or an interface to a server application. The application may generate one or more pages that are displayed during run-time when operated by a user. In an application that is used by multiple users, each user may have different access rights to different data objects in the application. The application may be, for example, a database application that includes data tables and fields within data tables. The data tables and/or fields may have access rights that restrict all but a select group of users from accessing certain restricted information. Employee social security numbers and employee salary information are examples of restricted information.

With continued reference to FIG. 2, the system 200 also includes a display 220 for displaying the pages from the application during run-time. A displayed page can include one or more objects. The objects may be menu entries, selectable tabs, fields, buttons, and so on. In FIG. 2, an example displayed page is shown as page 230 that includes objects labeled field1 235, field2 240, and field3 245.

The computer system 200 further includes a security audit logic 250 that is configured to determine secured objects and non-secured objects of the one or more displayed pages during run-time. Secured and non-secured objects may be determined based on access rights of the user that apply to the one or more objects. For example, secured objects include objects that the user does not have authority to access while non-secured objects include objects that the user has authority to access. Access rights to an object may be defined by roles and privileges assigned to a user as previously explained.

The security audit logic 250 may be configured to compare roles and privileges assigned to the user with roles and privileges that have authority to access the one or more objects. In another embodiment, the security audit logic 250 may be configured to be selectively activated on a displayed page by a user selection. Using the security audit logic 250, user access rights can be determined during run-time rather than entering a development environment of the application.

The security audit logic 250 can include logic to retrieve access rights 260 during run-time that are assigned to the user. The retrieved access rights 260 can be used to determine if access is authorized. In one embodiment, the access rights 260 can be retrieved from a memory 270 that may be, for example, a data store, a storage location, and so on. The memory 270 can be located in the computer 200 or on a remote computer. The access rights of the user may be stored as part of or retrieved by the application, in a table outside the application, in another location, in various formats and so on. In one embodiment, retrieving includes sending an electronic request to an appropriate server that would return information. Similarly, the security audit logic 250 can include logic to retrieve the access rights of the displayed page's objects during run-time so that comparisons can be performed. In some embodiments, the access rights of the user are initialized during deployment of the application. However in other embodiments, the access rights of the user may be initialized when a new user account (e.g. new employee account) is added to a company system for example where an employee joins a company after deployment of the application.

With further reference to FIG. 2, the system 200 further includes a display logic 280 configured to visually distinguish the secured objects from the non-secured objects on the displayed page 230. The visual differences are a way to visually indicate the access rights of the user and any mismatched rights. In one embodiment, the display logic 280 is configured to visually distinguish the secured objects from the non-secured objects by color coding the objects displayed on the displayed page 230 in different colors. For example, in FIG. 2, field1 235 and field2 240 are show with a white background, while field3 245 is visually distinguished with a black background. In one example, field3 245 may represent the secured object that the user does not have authority to access, while field1 235 and field2 240 are non-secured objects that the user has authority to access.

In another embodiment, the display logic 280 is configured to overlay a visual graphic on the one or more objects to visually distinguish the secured objects from the non-secured objects on the displayed page. Overlaying a visual graphic may include overlaying a color graphic, a text string, a symbol, and so on. In another embodiment, the display logic 280 may be configured to display one or more roles assigned to the user. Additionally, the display logic 280 may also be configured to display inherited roles of the one or more roles assigned to the user. Inherited roles are roles included in a parent role that contains multiple roles (e.g. multiple child roles). For example, the parent role of a human resources administrator role may include a role to authorize access to employee salary information and another role to authorize access to employee benefit information.

In still another embodiment, the display logic 280 may be configured to display the access rights of the user to a privileged user. For example, the access rights can be displayed to a network administrator (e.g. a privileged user) that is assisting the user to determine if errors exist in the application. Display of access rights to the privileged user may exclude data displayed by the one or more objects. For example, if the privileged user was to view a page containing sensitive/confidential information, the actual information displayed in the fields can be excluded and not be displayed. Instead, the information can be replaced with field labels (e.g. “Employee Salary Field 1,” “Employee Salary Field 2,” and so on).

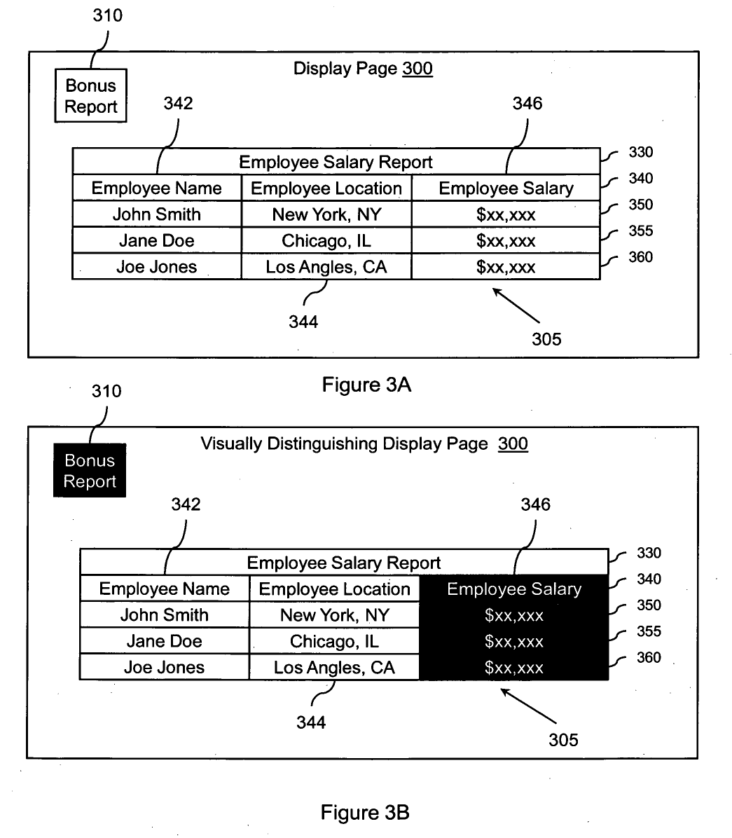

With reference to FIGS. 3A and 3B, one embodiment of a displayed page is shown to illustrate an example where a report can be generated or displayed during run-time and values for certain fields are not what were expected. For example, a displayed page 300 shows an employee salary report 305 and the salary information is displayed as $______. The user viewing the report might assume that an error occurred (e.g. in the query, in the application, etc.) and/or at least that something is not properly functioning. In this situation, the security audit feature as described above can be activated to determine if the unexpected behavior/results were caused by insufficient access rights rather than some other error.

Other types of objects on the page 300 can include for example a “Bonus Report” button 310 that may be activated by the user for executing and displaying bonus report results for the displayed employees. The employee salary report 305 may include a report header row 330 to describe the type of report, which in this case is the “Employee Salary Report.” The employee salary report 305 may further include column headers 340 for each column. For example, an “Employee Name” column 342, an “Employee Location” column 344, and an “Employee Salary” column 346. The columns can include any number of rows of data (e.g. rows 350, 355, 360, etc.)

Illustrated in FIG. 3B is one embodiment of the display page 300 after the security audit feature is performed on the page. For example after access rights are obtained and compared, the audit might determine that the user does not have appropriate access rights to view salary information or to access the “Bonus Report” button 310. Thus, the “Employee Salary” column 346 and the Bonus Report button 310 are visually distinguished as secured/non-accessible objects (e.g. color is changed to a black background). The accessible objects are displayed with no change or can also be changed with a different visual effect.

The visually distinguished objects shown after the security audit indicates that the cause of the unexpected results or errors was mismatched access rights of the user. The results of the audit can then be used to simply correct the user's access rights. In this manner, the security audit reveals mismatched access rights during run-time and avoids performing other time intensive troubleshooting and/or debugging

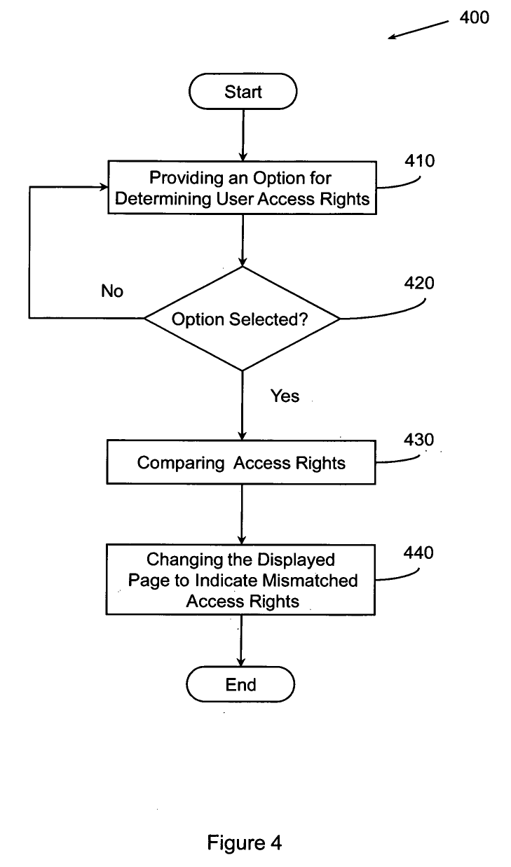

FIG. 4 illustrates another embodiment of a method 400 associated with performing a security audit in a user interface mode of a run-time environment. At block 410, the method 400 begins by providing an option (e.g. a security audit feature) for determining user access rights in a displayed page of a runtime environment. The displayed page may include one or more objects as previously described. The method 400 continues at 420, by determining if the option for determining user access rights is selected. A user may activate the option by selecting, on a displayed page, a button, a menu option, and so on.

If the option is selected at block 420, the method 400 continues at 430, by comparing access rights of the one or more objects on the displayed page to access rights assigned to the user. For example, the user would be identified by who is currently logged-into the executing application and is viewing the displayed page. The comparison of access rights determines accessible objects and non-accessible objects. In one embodiment, the non-accessible objects are objects that the user has no authority to access. The accessible objects include objects that the user has authority to access.

The method 400 may further include at 440, changing the displayed page to indicate mismatched access rights by indicating the accessible objects and the non-accessible objects. The objects can be visually distinguished from each other to show whether the objects are accessible or not. In one embodiment, the indication of mismatched access rights may be performed by overlaying a graphic(s) on the page and/or on an object. Additionally, the indication may be performed by changing the color of an object.

In another embodiment, the method 400 may further include providing an option to display the values of the access rights assigned to the user and the access rights of the one or more objects. This option may be provided on the displayed page and may be performed while in the application mode without having to switch to a development mode. In still another embodiment, the method 400 may include providing an option to select an object, on the displayed page, and to display the values of the access rights assigned to the user that correspond to the selected object. For example, the displayed values of access rights may be the rights assigned to the user that grant access to the selected object or show that insufficient rights are assigned.

In one embodiment, the method 400 may be implemented as computer executable instructions stored on a computer-readable medium. When executed by a machine (e.g., processor), the instructions cause the machine to perform the method 400. While executable instructions associated with the above method are described as being stored on a computer-readable medium, it is to be appreciated that executable instructions associated with other example methods described herein may also be stored on a computer-readable medium.

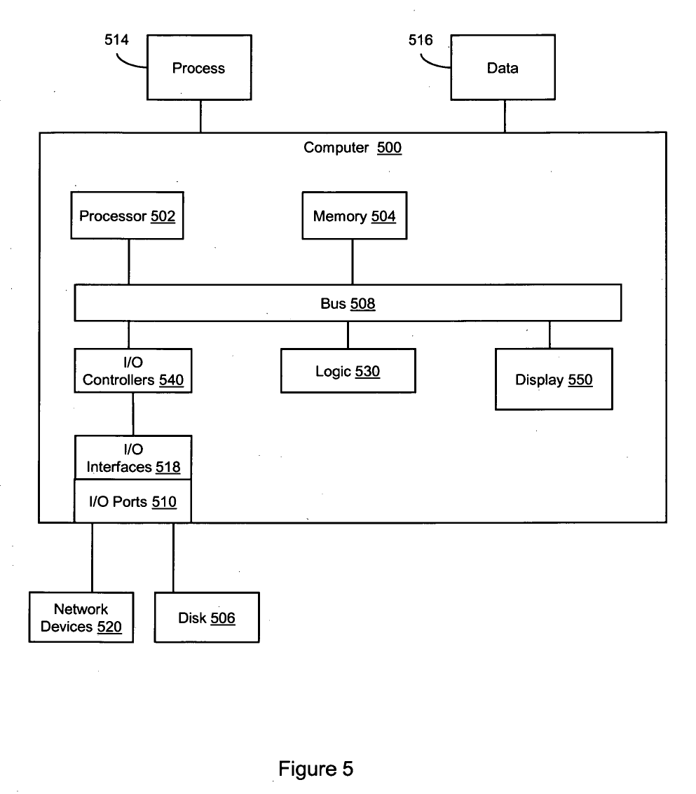

FIG. 5 illustrates an example computing device in which example systems and methods described herein, and equivalents, may operate. The example computing device may be a computer 500 that includes a processor 502, a memory 504, and input/output ports 510 operably connected by a bus 508. In one example, the computer 500 may include a logic 530 configured to facilitate determining secured objects and non-secured objects of the one or more displayed pages during run-time. The secured objects and the non-secured objects may be determined based on access rights of a user. In different examples, the security audit logic 530 may be implemented in hardware, software, firmware, and/or combinations thereof. While the logic 530 is illustrated as a hardware component attached to the bus 508, it is to be appreciated that in one example, the security audit logic 530 could be implemented in the processor 502.

Thus, logic 530 may provide means (e.g., hardware, software, firmware) for determining secured objects and non-secured objects of the one or more displayed pages during run-time. The secured objects and the non-secured objects may be determined based on access rights of a user as described herein.

In other embodiment, the means may be implemented, for example, as an ASIC or processor programmed to determine secured objects and non-secured objects of the one or more displayed pages during run-time. The secured objects and the non-secured objects may be determined based on access rights of a user. The means may also be implemented as computer executable instructions that are presented to computer 500 as data 516 that are temporarily stored in memory 504 and then executed by processor 502.

Logic 530 may also provide means (e.g., hardware, software, firmware) for visually distinguishing between the secured objects and the non-secured objects on the displayed page.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the i/o interfaces 518 and the input/output ports 510. Input/output devices may be, for example, a keyboard, a microphone, a pointing and selection device, cameras, video cards, display 550, the disk 506, the network devices 520, and so on. The input/output ports 510 may include, for example, serial ports, parallel ports, and USB ports.

Display 550 may also provide means (e.g., hardware, software, firmware) for displaying one or more pages of an executing application. A displayed page may include one or more objects. The display 550 may be a display logic that determines what is to be displayed to the user. The display 550 may also be a video card that formats data for a graphical user interface. The display 550 may also be a graphical user interface that displays graphics to the user.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A method for performing a security audit on a displayed page generated from an executing application, the displayed page being displayed on a display and including one or more current objects, the method comprising:
determining the one or more current objects on the displayed page;
determining access rights to the one or more current objects;
comparing access rights of the one or more current objects to access rights assigned to a user currently accessing the displayed page to determine accessible objects and non-accessible objects; and
visually distinguishing between the accessible objects and the non-accessible objects on the displayed page.

2. The method of claim 1, where determining the access rights to the one or more current objects further includes determining privileges of the one or more current objects and determining roles that allow access to the one or more current objects.

3. The method of claim 1, where comparing access rights further includes comparing roles and privileges assigned to a user with roles and privileges that have access to the one or more current objects, where the roles group together privileges or other roles and grant multiple privileges or roles to the user.

4. The method of claim 1 where visually distinguishing includes overlaying a visual graphic on the displayed page to visually distinguish the accessible objects from the non-accessible objects.

5. The method of claim 1, where visually distinguishing includes displaying the accessible objects in a different color from the non-accessible objects.

6. The method of claim 1, where visually distinguishing between the accessible objects and the non-accessible objects on the displayed page indicates access rights of the user to the object.

7. The method of claim 1, further including providing an option, on the displayed page, to activate the security audit on the displayed page of the executing application.

8. The method of claim 1, further including transmitting the displayed page, including the visually distinguished accessible objects and non-accessible objects, to a privileged user.

9. The method of claim 8, where transmitting the displayed page includes transmitting the one or more current objects, the access rights that authorize access to the one or more current objects, and the access rights assigned to the user.

10. The method of claim 9, where the transmitting transmits the displayed page without including data displayed by the one or more current objects, and where the privileged user may proxy as the user of the displayed page to allow the privileged user to interact with the displayed page as the user.

11. The method of claim 1, further including providing an option, on the displayed page, to change the access rights assigned to the user that is currently operating the executing application.

12. The method of claim 1, further including providing an option, on the displayed page, to display the access rights assigned to the user that is currently operating the executing application.

13. The method of claim 1, where the displayed page is generated from an application in a run-time environment.

14. The method of claim 1, further including providing an option, on the displayed page, to execute the security audit.

15. The method of claim 1, further including providing an option, on the displayed page, to select one of the one or more current objects and to display a list of user roles and privileges that include access rights to the selected object.

16. The method of claim 1, where the objects are menu entries, tabs, fields, and/or buttons.

17. A computer system, comprising:
a processor for executing an application, where the application generates one or more pages that are displayed during run-time when operated by a user;
a display for displaying the one or more pages, where a displayed page includes one or more objects;
a security audit logic configured to determine secured objects and non-secured objects of the one or more displayed pages during run-time, where the secured objects and the non-secured objects are determined based on access rights of the user to the one or more objects; and
a display logic configured to visually distinguish the secured objects from the non-secured objects on the displayed page to indicate the access rights of the user.

18. The system of claim 17, where the display logic is configured to overlay a visual graphic on the one or more objects to visually distinguish the secured objects from the non-secured objects on the displayed page.

19. The system of claim 17, where the display logic is configured to visually distinguish the secured objects from the non-secured objects by color coding objects displayed on the displayed page to indicate the access rights of the user.

20. The system of claim 17, where the security audit logic is configured to compare roles and privileges assigned to the user with roles and privileges that have authority to access the one or more objects, where the secured objects are objects that the user has no authority to access, and where the non-secured objects are objects that the user has authority to access.

21. The system of claim 17, where the privileges are a right to access an object, where the roles group together privileges or other roles, and where the roles grant multiple privileges or roles to the user.

22. The system of claim 17, where the display logic is configured to display one or more roles assigned to the user and to display inherited roles of the one or more roles assigned to the user, and where the inherited roles are roles included in a parent role.

23. The system of claim 17, where the display logic is configured to display the access rights of the user to a privileged user, and where the display of the access rights to the privileged user excludes data displayed by the one or more objects.

24. The system of claim 17, where the objects are menu entries, tabs, fields, and/or buttons.

25. The system of claim 17, where the security audit logic is configured to be selectively activated on a displayed page by a user selection.

26. The system of claim 17, where the security audit logic further includes logic to retrieve the access rights assigned to the user during run-time.

27. The system of claim 26, where the security audit logic further includes logic to retrieve the access rights of the one or more objects during run-time.

28. A computer-readable medium storing computer-executable instructions that when executed by a computer cause the computer to perform a method, the method comprising:
providing an option for determining user access rights in a displayed page of a runtime environment, the displayed page including one or more objects;
if the option is selected:
comparing access rights of the one or more objects on the displayed page to access rights assigned to a user to determine accessible objects and non-accessible objects; and
changing the displayed page to indicate mismatched access rights by indicating the accessible objects and the non-accessible objects.

29. The computer-readable medium of claim 28, further including instructions for providing an option to display the access rights assigned to the user and the access rights of the one or more objects.

30. The computer-readable medium of claim 28, further including instructions for providing an option to select a object, on the displayed page, to display access rights assigned to the user that grant access to the selected object.

31. The computer-readable medium of claim 28, where determining accessible objects and non-accessible objects includes determining the non-accessible objects as objects that the user has no authority to access, and determining the accessible objects as objects that the user has authority to access.

32. A system, comprising:
means for displaying one or more pages of an executing application, where a displayed page includes one or more objects;
means for determining secured objects and non-secured objects of the one or more displayed pages during run-time, where the secured objects and the non-secured objects are determined based on access rights of a user; and
means for visually distinguishing between the secured objects and the non-secured objects on the displayed page.
